(19) United States
(12) Patent Application Publication
(10) Pub. No.: US 2010/0312922 A1
(43) Pub. Date: Dec. 9, 2010

(54) SYSTEM AND METHOD FOR IDENTIFYING PHYSICAL LOCATION OF ETHERNET-CONNECTED MEDIA DRIVES IN A MEDIA LIBRARY ASSEMBLY

(75) Inventor: Clinton R. DeHerrera, Littleton, CO (US)

Correspondence Address: James P. Broder;Roeder & Broder LLP, 9915 Mira Mesa Blvd. Suite 300, San Diego, CA, 92131, US

(73) Assignee: QUANTUM CORPORATION

(21) Appl. No.: 12/481,335

(22) Filed: Jun. 9, 2009

(51) Int. Cl. G06F 3/00; G06F 12/00

(52) U.S. Cl. 710/16; 711/111; 710/62; 711/E12.001

(57) ABSTRACT

A system and method for identifying a physical location of an Ethernet-connected media drive in a media library assembly includes connecting a first drive bay that receives the media drive to a hardware identification board; connecting the hardware identification board to an Ethernet switch with an Ethernet cable; transmitting a signal including a hardware identification of the first drive bay from the hardware identification board to the Ethernet switch via the Ethernet cable; and generating a routing table including the hardware identification of the first drive bay at the Ethernet switch. The method can include providing the routing table to a library controller of the media library assembly. The method can include the library controller issuing a logical communication address that is based on the hardware identification of the first drive bay. The step of transmitting a signal can include setting a configuration of a plurality of switches within the hardware identification board based on the hardware identification of the first drive bay. The signal can be a 4-bit signal.

### BACKGROUND

Storage media suitable for storing vast amounts of information content include streaming tape cartridges. Streaming tape drives are used to transfer multiple blocks of user data to and from the tape cartridges in a single streaming operation, rather than as a series of start-stop operations. Streaming tape is particularly well suited for backup operations as well as for providing archival and retrieval operations for vast quantities of information.

For even greater storage capacity, a plurality of tape drives and multiple tape cartridges can be positioned within a tape library. In these types of tape libraries, a library controller needs to be able to distinguish between the various tape drives within the library. Typically, this can be accomplished by associating a physical address of the tape drive with a logical address of the tape drive. A tape drive controller, separate from the tape drive itself, used in conjunction with a physical address, defined externally from the tape drive, has been used in conventional systems. In this type of system, the tape drive controller would read a dip switch or a geographical address representing the physical location of the tape drive.

In the past, the tape library system controller of certain systems would use a predefined map between the logical communication address and the physical location address. When the tape library system controller received a message from a tape drive with a certain logical communication address, the tape library system controller associated the tape drive to its location in the tape library using the predefined map.

However, in a tape library (or another type of media library) with tape drives directly connected using Ethernet with no intermediary tape drive controller, reading the physical location has previously not been accomplished without at least requiring inconvenient and/or costly modification to the tape drives.

### SUMMARY

The present invention is directed toward a method for identifying a physical location of one of a plurality of Ethernet-connected media drives in a media library assembly. In one embodiment, the method includes the steps of connecting a first drive bay that receives a media drive to a hardware identification board; connecting the hardware identification board to an Ethernet switch with an Ethernet cable; transmitting a signal including a hardware identification of the first drive bay from the hardware identification board to the Ethernet switch via the Ethernet cable; and generating a routing table at the Ethernet switch, the routing table including the hardware identification of the first drive bay.

In another embodiment, the method also includes providing the routing table to a library controller of the media library assembly using an Ethernet connection. In yet another embodiment, the method can include issuing a logical communication address to the first drive bay with the library controller. In this embodiment, the logical communication address is based on the hardware identification of the first drive bay.

In one embodiment, the step of issuing includes storing the logical communication address in the routing table. In another embodiment, the step of transmitting a signal can include setting a configuration of a plurality of switches within the hardware identification board based on the hardware identification of the first drive bay. The signal from the hardware identification board can be transmitted via four lines in the Ethernet cable. In certain embodiments, the signal can be a 4-bit signal.

In another embodiment, the method can include the steps of connecting 16 drive bays to 16 corresponding hardware identification boards, each drive bay being adapted to receive a corresponding media drive; connecting the 16 hardware identification boards to an Ethernet switch, wherein each connection between each the 16 hardware identification boards and the Ethernet switch includes a corresponding Ethernet cable; transmitting a signal from each of the hardware identification boards to the Ethernet switch via corresponding Ethernet cables, the signals including hardware identifications of each of the drive bays; generating a routing table at the Ethernet switch, the routing table including the hardware identifications of each of the drive bays; providing the routing table to a library controller of the media library assembly using an Ethernet connection; issuing a logical communication address for each of the drive bays with the library controller, each of the logical communication addresses being based on the hardware identification of the corresponding drive bay; and storing the logical communication addresses in the routing table.

The present invention is also directed toward a media library assembly. In one embodiment, the media library assembly includes a plurality of drive bays, an Ethernet switch and a plurality of hardware identification boards. Each drive bay is adapted to receive a corresponding media drive. In one embodiment, the hardware identification boards are each configured based on a hardware identification of a corresponding drive bay. Further, a signal is transmitted from the hardware identification boards to the Ethernet switch via an Ethernet cable. In certain embodiments, each signal includes a hardware identification that identifies a physical location of the corresponding drive bay.

### BRIEF DESCRIPTION OF THE DRAWINGS

The invention, together with further advantages thereof, may best be understood by reference to the following description taken in conjunction with the accompanying drawings, taken in conjunction with the accompanying description, in which similar reference characters refer to similar parts, and in which:

FIG. 1 is a schematic block diagram of one embodiment of a media library assembly having features of the present invention including a library controller, a plurality of Ethernet-connected media drives, a hardware identification assembly and an Ethernet switch;

FIG. 2 is a schematic illustrating a hardware identification board having a plurality of connections to communication links;

FIG. 3A illustrates a schematic diagram of one embodiment of the media library assembly having features of the present invention;

FIG. 3B illustrates one embodiment of a routing table generated by the Ethernet switch illustrated in FIG. 3A, including a listing of Ethernet switch ports, IP addresses, hardware identifications and associated physical addresses for the Ethernet switch ports; and

FIG. 4 is a flow chart showing steps of one embodiment of a method for identifying physical location of Ethernet-connected media drives in the media library assembly.

### DESCRIPTION

The present invention includes a system and method for identifying a physical location of an Ethernet-connected device in a media library system. The type of Ethernet-connected device can vary, but in the example provided herein, the Ethernet-connected device is a media drive, such as a tape drive. The system and method provided herein can be utilized in any suitable Ethernet network, such as 10 Base-T or 100 Base-T, as non-exclusive examples.

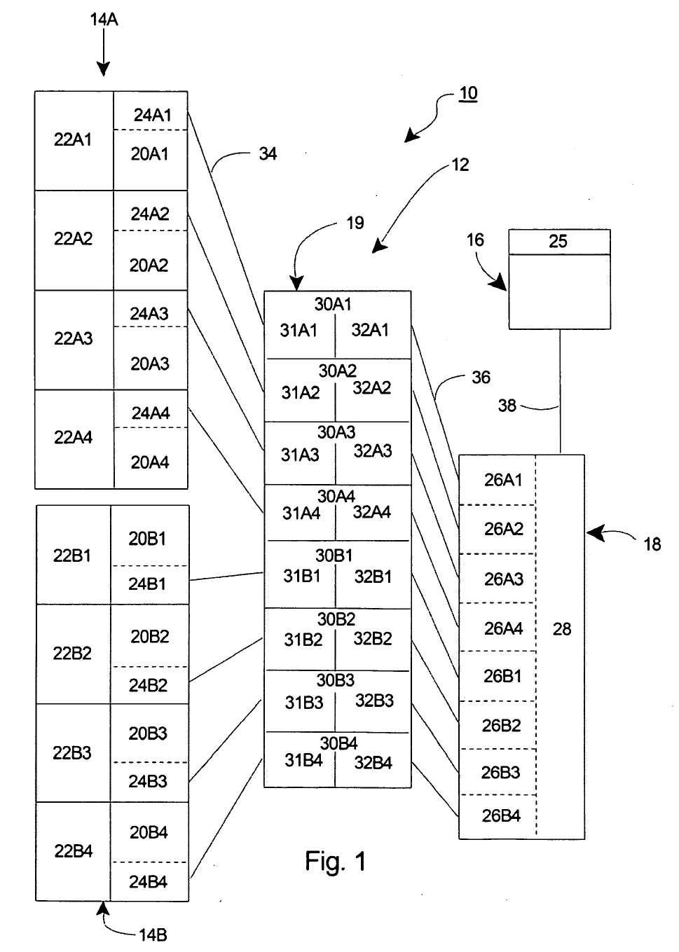

FIG. 1 is a schematic block diagram of a media library assembly 10 including one or more media libraries 12. For ease of description, the media library assembly 10 illustrated in FIG. 1 includes a single media library 12. However, it is understood that the media library assembly 10 can include any suitable number of media libraries 12 that are communicatively connected to one another. Additionally, the media library assembly 10 described herein is particularly suited to media that include magnetic storage tapes used in Ethernet-connected devices, as provided below. However, this reference to magnetic storage tapes is not intended to limit the invention in any manner. It is understood that media libraries using different types of Ethernet-connected media drives or other Ethernet-connected devices can be utilized with the present invention, such as virtual tape drives, optical drives and magneto-optical drives, as non-exclusive examples.

In the case of multiple media libraries 12 within the media library assembly 10, the relative location of the media libraries 12 can be varied. For example, the media libraries 12 can all be located in one on-site, central location, such as a single storage room or data storage facility. Alternatively, one or more of the media libraries 12 can be located in a separate room from one or more of the other media libraries 12. Still alternatively, one or more of the media libraries 12 can be located off-site in a completely separate structure. In yet another embodiment, one or more media libraries 12 can be located in another state, province or country, or on another continent from one or more of the remaining media libraries 12.

The media library assembly 10 can also include a plurality of library communication links (not shown) that allow communication between the various media libraries 12. The library communication links between the media libraries 12 can be varied, and can include one or more different types of library communication links within the media library assembly 10, as generally known by those skilled in the art.

In the embodiment illustrated in FIG. 1, the media library assembly 10 includes (i) one or more drive modules including a first drive module 14A and a second drive module 14B, (ii) one or more library controllers 16, (iii) one or more Ethernet switches 18 and (iv) one or more hardware identification assemblies 19. Although two drive modules 14A, 14B are illustrated in FIG. 1, it is recognized that any suitable number of drive modules can be included in the media library assembly 10. The first drive module 14A can include a plurality of first drive bays 20A1-20A4. The second drive module 14B can include a plurality of second drive bays 20B1-20B4. Each drive bay 20A1-20A4, 20B1-20B4 can receive a corresponding pluggable media drive 22A1-22A4, 22B1-22B4. In one embodiment, any media drive 22A1-22A4, 22B1-22B4 can plug into any drive bay 20A1-20A4, 20B1-20B4 in any drive module 14A, 14B. It is recognized that although four drive bays 20A1-20A4, 20B1-20B4 and media drives 22A1-22A4, 22B1-22B4 are included in each drive module 14A, 14B, the number of drive bays 20A1-20A4, 20B1-20B4 and corresponding media drives 22A1-22A4, 22B1-22B4 in each drive module 14A, 14B can vary to suit the design requirements of the media library assembly 10. For example, in various embodiments, 16 drive bays and 16 corresponding media drives are associated with each Ethernet switch 18, as described in greater detail below.

Each media drive 22A1-22A4, 22B1-22B4 can read data from and/or write data to one or more storage media (not shown). In one embodiment, one or more of the media drives 22A1-22A4, 22B1-22B4 is an Ethernet-connected media drive. For example, in one embodiment, all of the media drives 22A1-22A4, 22B1-22B4 can be Ethernet-connected media drives. Further, one or more of the media drives 22A1-22A4, 22B1-22B4 includes a tape drive that receives a tape cartridge, such as DLT™ tape media, LTO Ultrium™ media, DAT/DDS media, Travan™ media, SDLT™ tape media, etc., manufactured and sold by Quantum Corporation, as non-exclusive examples. In non-exclusive alternative embodiments, one or more of the media drives 22A1-22A4, 22B1-22B4 can include a drive for a different type of storage media, such as optical, magneto-optical, hard disk, virtual tape, or any other suitable type of storage media. Additionally, in certain embodiments, each drive bay 20A1-20A4, 20B1-20B4 includes a corresponding Ethernet bay port 24A1-24A4, 24B1-24B4 (sometimes referred to herein simply as a “bay port”). In an alternative embodiment, each bay port 24A1-24A4, 24B1-24B4 can be included as part of the corresponding media drive 22A1-22A4, 22B1-22B4, instead of being included as part of the corresponding drive bay 20A1-20A4, 20B1-20B4.

In one embodiment, the library controller 16 can include a standard programmable general purpose computer formed on a single plug-in card unit. The library controller 16 can include a programmed microprocessor or microcontroller according to the present invention, memory, communication interface, control interface, connectors, etc. In certain embodiments, the library controller 16 can utilize a mapping server 25, such as a Dynamic Host Configuration Protocol (DHCP) server, to assign logical communication addresses, such as Internet Protocol (IP) addresses, to each media drive 22A1-22A4, 22B1-22B4 and/or drive bay 20A1-20A4, 20B1-20B4 in the media library assembly 10, as described in greater detail below. The mapping server 25 supervises and distributes logical communication addresses from the library controller 16 and, as provided herein, automatically sends a new logical communication address when a media drive 22A1-22A4, 22B1-22B4 is plugged into a different drive bay 20A1-20A4, 20B1-20B4 in the media library assembly 10.

The Ethernet switch 18 is used to directly or indirectly connect one, some or all of the media drives 22A1-22A4, 22B1-22B4 with the library controller 16 and/or with one another. The Ethernet switch 18 can receive and/or inspect a data packet before transmitting the data packet to the library controller 16 or to one of the media drives 22A1-22A4, 22B1-22B4. In the embodiment illustrated in FIG. 1, the Ethernet switch 18 includes a plurality of Ethernet switch ports 26A1-26A4, 26B1-26B4 (sometimes referred to herein simply as a “switch port”). Although only eight switch ports 26A1-26A4, 26B1-26B4 are illustrated in FIG. 1, it is recognized that the Ethernet switch can include greater or fewer than eight switch ports 26A1-26A4, 26B1-26B4. For example, in one embodiment, the Ethernet switch can include 16 switch ports, and can include 64 digital inputs (four digital inputs for each switch port), as provided herein. Additionally, the Ethernet switch creates and/or stores a routing table 28 that records and/or stores various information received from the hardware identification assembly 19 and/or the library controller 16, as described in greater detail below.

The hardware identification assembly 19 transmits unique hardware identifications of the drive bays 20A1-20A4, 20B1-20B4 from the bay ports 24A1-24A4, 24B1-24B4 to the Ethernet switch 18. The design of the hardware identification assembly 19 can vary depending upon the design requirements of the media library assembly 10. In the embodiment illustrated in FIG. 1, the hardware identification assembly 19 includes a plurality of hardware identification boards 30A1-30A4, 30B1-30B4. Each hardware identification board 30A1-30A4, 30B1-30B4 includes a corresponding first board port 31A1-31A4, 31B1-31B4 and a corresponding second board port 32A1-32A4, 32B1-32B4. For example, hardware identification board 30B2 includes a first board port 31B2 and a second board port 32B2.

Although eight hardware identification boards 30A1-30A4, 30B1-30B4 are depicted in the hardware identification assembly illustrated in FIG. 1, it is recognized that any suitable number of hardware identification boards can be utilized. In one embodiment, the number of hardware identification boards directly corresponds to the number of connected drive bays 20A1-20A4, 20B1-20B4 and/or bay ports 24A1-24A4, 24B1-24B4. It is understood that although the hardware identification boards 30A1-30A4, 30B1-30B4 are connected to the bay ports 24A1-24A4, 24B1-24B4, this connection is also an indirect connection between the between the hardware identification boards 30A1-30A4, 30B1-30B4 and the drive bays 20A1-20A4, 20B1-20B4 and/or the media drives 22A1-22A4, 22B1-22B4. In an alternative embodiment, each hardware identification board 30A1-30A4, 30B1-30B4 is included within the corresponding media drive 22A1-22A4, 22B1-22B4 and/or the corresponding drive bay 20A1-20A4, 20B1-20B4.

In another embodiment, each hardware identification board 30A1-30A4, 30B1-30B4 can be connected to greater than one bay port 24A1-24A4, 24B1-24B4. In one embodiment, the hardware identification boards 30A1-30A4, 30B1-30B4 are spaced apart from one another, i.e. are separate and not attached to one another. In another embodiment, the hardware identification boards 30A1-30A4, 30B1-30B4 can be grouped together and/or physically connected to one another, or configured as a unitary structure.

In certain embodiments, each first board port 31A1-31A4, 31B1-31B4 is connected to one bay port 24A1-24A4, 24B1-24B4 via a first communication link 34 (only one of the eight first communication links 34 is labeled in FIG. 1 for clarity). Further, each second board port 32A1-32A4, 32B1-32B4 is connected to one Ethernet switch port 26A1-26A4, 26B1-26B4 via a second communication link 36 (only one of the eight second communication links 36 is labeled in FIG. 1 for clarity). In one non-exclusive embodiment, the first communication link 34 and/or the second communication link 36 each includes an Ethernet cable, such as a standard 8-wire, twisted pair cable, as one non-exclusive example.

In one embodiment, the unique hardware identification of each drive bay 20A1-20A4, 20B1-20B4 is set within the corresponding hardware identification board 30A1-30A4, 30B1-30B4. For example, the hardware identification boards 30A1-30A4, 30B1-30B4 can be wired during setup and/or connection with the drive bays 20A1-20A4, 20B1-20B4 so that each hardware identification board includes a wiring pattern or switch pattern that is based on the hardware identification of the corresponding drive bay 20A1-20A4, 20B1-20B4, as described in greater detail below. Once the hardware identification boards 30A1-30A4, 30B1-30B4 have been set in this manner, the hardware identification for each hardware identification board 30A1-30A4, 30B1-30B4 is then transmitted to one of the Ethernet switch ports 26A1-26A4, 26B1-26B4 of the Ethernet switch 18. In one embodiment, this transmission occurs via four of the eight standard Ethernet cable lines, as described in greater detail below.

The routing table 28 can then be created in the Ethernet switch 18. The Ethernet switch 18 can then provide this routing table 28 (including the hardware identification) to the DHCP server 25 of the library controller 16 via a third communication link 38, such as a standard Ethernet connection, for example. At this point, a unique logical address (such as an internet protocol address) that is based on physical location of the drive bays 20A1-20A4, 20B1-20B4 and/or the media drives 22A1-22A4, 22B1-22B4 can be issued for each Ethernet-connected media drive 22A1-22A4, 22B1-22B4 and each corresponding Ethernet switch port 26A1-26A4, 26B1-26B4. As used herein, for ease of discussion, the physical location of a particular drive bay 20A1-20A4, 20B1-20B4 is used interchangeably with the physical location of a corresponding media drive 22A1-22A4, 22B1-22B4 and/or a corresponding bay port 24A1-24A4, 24B1-24B4.

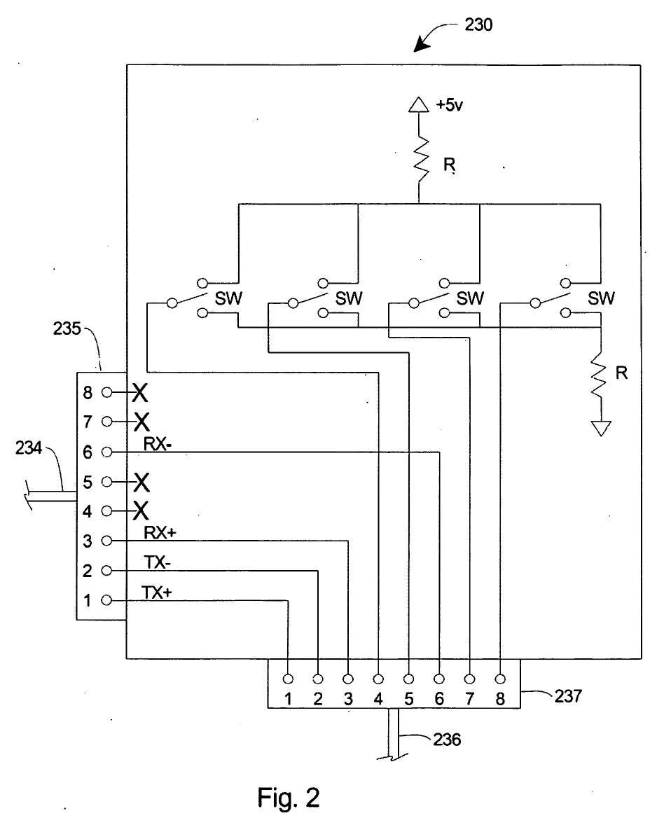

FIG. 2 is a schematic illustrating one embodiment of the hardware identification board 230. In this embodiment, the hardware identification board includes a plurality of communication links, including a first connection 235 and a second connection 237. The first connection 235 receives the first communication link 234, such as an Ethernet cable, as one non-exclusive example. The second connection 237 receives the second communication link 236, which can also include an Ethernet cable.

In the embodiment illustrated in FIG. 2, the first communication link 234 is an Ethernet cable that includes eight lines. In this embodiment, lines 1, 2, 3 and 6 are used to transmit data, as is typical in a standard Ethernet connection. In one embodiment, each of lines 4, 5, 7 and 8 within the hardware identification board 230 can be controlled by a manually-set switch (indicated as “SW” in FIG. 2). Alternatively, the switches can be automatically controlled by the drive bay 20A1-20A4, 20B1-20B4 and/or media drive 22A1-22A4, 22B1-22B4. These switches are either set to high or low so that each of the four lines transmits one identification bit based on the physical location of the drive bay 20A1-20A4, 20B1-20B4 and/or media drive 22A1-22A4, 22B1-22B4, to make up a 4-bit hardware identification. In this embodiment, 16 possible hardware identifications corresponding to 16 physical locations of the drive bays 20A1-20A4, 20B1-20B4 and/or media drives 22A1-22A4, 22B1-22B4 can be generated by these “high/low” switch settings.

Further, in this embodiment, the second communication link 236 is an Ethernet cable that also includes eight lines. In one embodiment, lines 1, 2, 3 and 6 are used to transmit data to the Ethernet switch 18 (illustrated in FIG. 1), while one or more of lines 4, 5, 7 and 8 are used to transmit the combined 4-bit signal of the hardware identification of the specific drive bay 20A1-20A4, 20B1-20B4 to the Ethernet switch 18. Therefore, in one embodiment, each Ethernet switch 18 can accommodate and track drive bays for 16 media drives 22A1-22A4, 22B1-22B4, via 64 digital inputs (4 inputs for each switch port) that provide the hardware identification information to the Ethernet switch 18.

In non-exclusive alternative embodiments, rather than using switches, one or more of lines 4, 5, 7 and 8 could be permanently wired or otherwise set to either high or low provided that each hardware identification board 230 includes lines that are wired differently from one another so that a unique hardware identification is established for each drive bay 20A1-20A4, 20B1-20B4. Stated another way, each drive bay 20A1-20A4, 20B1-20B4 would be associated with a particular hardware identification board wiring so that each uniquely wired hardware identification board 230 is permanently associated with the physical location of a corresponding drive bay 20A1-20A4, 20B1-20B4.

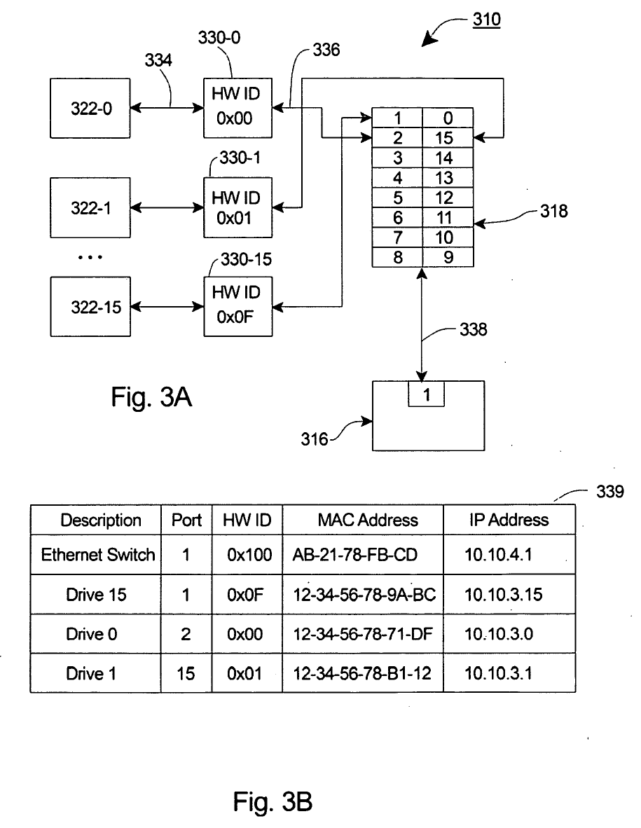

FIG. 3A is a schematic diagram of one embodiment of a portion of the media library assembly 310. FIG. 3A is intended to represent media drives 322-0 through 322-15, although not all media drives are explicitly illustrated. As each media drive is connected to each corresponding hardware identification board 330-0 through 330-15 (not all hardware identification boards 330-0 through 330-15 are shown in FIG. 3A), the hardware identification (illustrated as HW ID in FIG. 3A) of each media drive 322-0 through 322-15 is configured within the hardware identification board based on the hardware identification of the corresponding media drives 322-0 through 322-15. For example, in this embodiment, the hardware identification for media drive 322-0 is 0x00, the hardware identification for media drive 322-1 is 0x01, and the hardware identification for media drive 322-15 is 0x0F. These hardware identifications are then transmitted via the second communication links 336 (only one second communication link 336 is labeled in FIG. 3A) to a particular switch port (illustrated as 0 through 15 in FIG. 3A) of the Ethernet switch 318 for generation of a routing table 339 (illustrated in FIG. 3B).

At this point, when required, the routing table 339 can be transmitted to one specific port (illustrated as port “1” in FIG. 3A) of a plurality of ports (other ports not shown in FIG. 3A) of the library controller 316 via the third communication link 338. Once the library controller 316 receives the routing table 339, the DHCP server 25 (illustrated in FIG. 1) can assign a logical communication address (IP address) that is based on the physical location of each connected media drive 322-0 through 322-15 and/or each Ethernet switch 318. With this design, the library controller 316 knows the hardware identification, and thus the physical location, of each media drive 322-0 through 322-15 that is connected to that specific Ethernet switch 318, and the physical location of the Ethernet switch 318. Somewhat similarly, the library controller 316 can track the physical location (and hardware identifications) of each media drive that is connected to other Ethernet switches, as well as the physical location of those other Ethernet switches, within the media library assembly 310.

FIG. 3B is a portion of one embodiment of a routing table 339 that can be generated by the Ethernet switch 318 (illustrated in FIG. 3A) based on the configuration illustrated in FIG. 3A. In this embodiment, the routing table can include one or more of a description of the media drive or Ethernet switch, a port number, a hardware identification (HW ID), a MAC address, and a logical communication address such as the IP address.

For example, a logical communication address request coming from media drive 322-0 (and its corresponding drive bay) would be assigned a particular logical communication address, i.e. 10.10.3.0. A logical communication address request coming from media drive 322-1 (and its corresponding drive bay) would be assigned a particular logical communication address, i.e. 10.10.3.1, and so on. With this design, the library controller 316 has accurate mapping of the logical communication addresses with the physical locations of the media drives. Thus, the mapping server 25 of the library controller 316 does not just randomly select a logical communication address to be assigned to a particular physical address. Rather, the mapping server 25 consults the routing table 339 first before assigning a logical communication address.

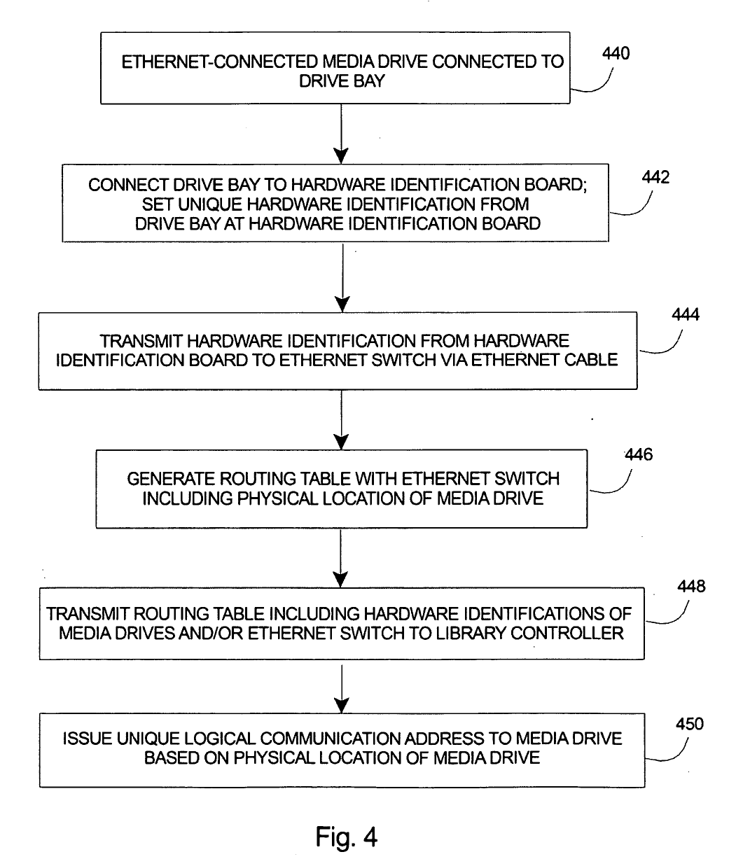

FIG. 4 is a flow chart showing a series of steps for one embodiment of a method for identifying a physical location of an Ethernet-connected device within a media library assembly. In this embodiment, at step 440, an Ethernet-connected media drive is plugged into or otherwise connected to a drive bay.

At step 442, the drive bay is connected to a hardware identification board, and the hardware identification board is wired or otherwise set based on a unique hardware identification of the drive bay.

At step 444, the unique hardware identification is transmitted via the second communication link such as an Ethernet cable, and is received by one corresponding Ethernet switch port of the Ethernet switch.

At step 446, a routing table is generated by the Ethernet switch, which includes the hardware identification (physical location) of each of the connected media drives and/or the Ethernet switch.

At step 448, the routing table is transmitted to the DHCP server (mapping server) of the library controller.

At step 450, the library controller issues a unique logical communication address (IP address) to each media drive and the corresponding Ethernet switch based on the physical location of each such component.

It is recognized that the embodiment described and illustrated relative to FIG. 4 is provided as a representative example. Other embodiments can be utilized with the present invention which may omit one or more steps described herein, or may add one or more steps that may be obvious to one skilled in the art.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for identifying a physical location of one of a plurality of Ethernet-connected media drives in a media library assembly, the method comprising the steps of:
connecting a first drive bay that receives a media drive to a hardware identification board;
wiring the hardware identification board to identify a hardware identification of the first drive bay;
connecting the hardware identification board to an Ethernet switch with an Ethernet cable;
transmitting a signal from the hardware identification board to the Ethernet switch via the Ethernet cable, the signal including the hardware identification of the first drive bay; and
generating a routing table at the Ethernet switch, the routing table including the hardware identification of the first drive bay.

2. The method of claim 1 further comprising the step of providing the routing table to a library controller of the media library assembly using an Ethernet connection.

3. The method of claim 2 further comprising the step of issuing a logical communication address to the first drive bay with the library controller, the logical communication address being based on the hardware identification of the first drive bay.

4. The method of claim 3 wherein the step of issuing includes storing the logical communication address in the routing table.

5. The method of claim 1 wherein the step of wiring includes controlling a configuration of a plurality of switches within the hardware identification board based on the hardware identification of the first drive bay.

6. The method of claim 5 wherein the step of transmitting includes transmitting the signal via four lines in the Ethernet cable.

7. The method of claim 6 wherein the signal is a 4-bit signal.

8. The method of claim 1 wherein the step of connecting a first drive bay includes connecting a plurality of drive bays to a plurality of corresponding hardware identification boards.

9. The method of claim 8 wherein the step of connecting the hardware identification board includes connecting a plurality of hardware identification boards to the Ethernet switch, wherein each connection between each the hardware identification board and the Ethernet switch includes a corresponding Ethernet cable.

10. The method of claim 9 wherein the step of connecting the hardware identification board includes connecting 16 hardware identification boards to the Ethernet switch with 16 Ethernet cables.

11. The method of claim 1 wherein the step of connecting the hardware identification board includes the Ethernet switch having 64 digital inputs.

12. The method of claim 1 wherein the step of wiring includes hardwiring the hardware identification board in a unique configuration that is permanently associated with the hardware identification of the first drive bay.

13. A media library assembly that utilizes the method of claim 1.

14. A media library assembly comprising:
a plurality of drive bays, each drive bay being adapted to receive a corresponding media drive;
an Ethernet switch; and
a plurality of hardware identification boards that each is connected to one of the plurality of drive bays, each hardware identification board being uniquely configured based on a hardware identification of the corresponding drive bay, the hardware identification boards each transmitting a signal to the Ethernet switch via a Ethernet cable, each signal including the hardware identification of the corresponding drive bay.

15. The media library assembly of claim 14 wherein the Ethernet switch generates a routing table that is based at least partially on the signals received from the plurality of hardware identification boards.

16. The media library assembly of claim 15 further comprising a library controller that receives the routing table from the Ethernet switch.

17. The media library assembly of claim 16 wherein the library controller is configured to issue a logical communication address for each of the media drives.

18. The media library assembly of claim 17 wherein the library controller stores the logical communication addresses for each media drive in the routing table.

19. The media library assembly of claim 14 wherein the hardware identification boards each includes a plurality of switches that are set based on the hardware identification of the corresponding drive bay, wherein a configuration of the switches identifies the physical location of the corresponding drive bay.

20. A method for identifying the physical location of one of a plurality of Ethernet-connected media drives that includes utilizing the media library assembly of claim 14.

21. A method for identifying a physical location of one of a plurality of Ethernet-connected media drives in a media library assembly, the method comprising the steps of:
connecting 16 drive bays to 16 corresponding hardware identification boards, each drive bay being adapted to receive a corresponding media drive;
connecting the 16 hardware identification boards to an Ethernet switch, wherein each connection between each the 16 hardware identification boards and the Ethernet switch includes a corresponding Ethernet cable;
transmitting a signal from each of the hardware identification boards to the Ethernet switch via the corresponding Ethernet cable, the signals including hardware identifications of each of the drive bays;
generating a routing table at the Ethernet switch, the routing table including the hardware identifications of each of the drive bays;
transmitting the routing table to a library controller of the media library assembly;
issuing a logical communication address for each of the drive bays with the library controller, each of the logical communication addresses being based on the hardware identification of the corresponding drive bay; and
storing the logical communication addresses in the routing table.

22. The method of claim 21 wherein the step of transmitting a signal includes setting a configuration of a plurality of switches within each hardware identification board based on the hardware identification of the corresponding drive bay.

23. The method of claim 21 wherein each signal is a 4-bit signal.
